(19) United States
(12) Patent Application Publication
(10) Pub. No.: US 2004/0215486 A1
(43) Pub. Date: Oct. 28, 2004

(54) Prescription labeling system and method of use

(75) Inventor: Robert Braverman, Jamison, PA (US)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(73) Assignee: Medi-Dose, Inc., Warwick, PA

(21) Appl. No.: 10/421,061

(22) Filed: Apr. 23, 2003

(51) Int. Cl. G06F 17/60

(52) U.S. Cl. 705/2

(57) ABSTRACT

A system and method a system and method for printing a label, e.g., a labeled lid, for a package, e.g., a multi-compartment package, containing a pharmaceutical. The system makes use of the NDC code for the particular pharmaceutical to be held within the package to enable the user of the system to use that code to accurately print the label with selected indicia associated with the pharmaceutical, e.g., its name, dosage, etc. The indicia can be printed in a visually enhanced manner, e.g., in bold, italics, underscored and/or color.

### FIELD OF THE INVENTION

The invention relates generally to systems for packaging prescription drugs and more particularly to systems for printing labels for use on unit dose or multiple dose packages for prescription drugs.

### BACKGROUND OF THE INVENTION

In U.S. Pat. No. 3,780,856 (Braverman), which is assigned to the same assignee as this invention, Medi-Dose, Inc., and whose disclosure is incorporated by reference herein, there is disclosed a medicinal dispensing device having a base member and a cover sheet or closure. The base member comprises a plurality of chambers surrounded by flanges having corners that are detachably connected along certain lines so that each flange may be separated from the remaining flanges. Each chamber has an outer opening depending from the flanges and is adapted to hold a drug, tablet, capsule, etc. The cover sheet or closure is in the form of a continuous planar member covering the chamber openings with certain portions of the interior surface of the closure being in contact with the flanges. The cover sheet is perforated along certain lines closely corresponding to the flange lines. Certain portions of the interior surface of the cover sheet are provided with a tacky adhesive coating which is in contact with the flanges, and certain other areas of the interior surface of the closure member are non-tacky to overlie the chamber openings. At least one corner of each flange is arranged to be removed in a cut-away area so that the existing corner of the closure member overlies the cut-away area to function as a lift tab to facilitate the separation of a portion of the cover sheet from a particular flange to provide access to the contents of the chamber. The flanges may be provided in a five-by-five array, there being a cut-away area for at least one corner of every flange that is provided by the formation of a minimum number of punched openings, which minimum number is far less than the total number of 16 intersections that exist in the 5×5 array. The cover sheet is arranged to have indicia, e.g., instructions for taking the drug contained in the associated chamber, placed on it in the location of the chamber(s).

In U.S. Pat. No. 5,603,409 (Braverman), which is also assigned to the same assignee as this invention, and whose disclosure is incorporated by reference herein, there is disclosed a medicinal dispensing device preferably including 25 units arranged in a square having five units on a side. Each unit includes flanges having corners and being detachably connected so that each flange may be separated from the remaining flanges. A chamber depends from each flange and has an outer opening and is adapted to hold an article. A cover sheet in the form of a closure covers the chamber openings and has an interior surface which is in contact with the flanges. The interior surface carries a tacky adhesive which contacts the flanges and is protected from adherence by a protective cover sheet. The cover sheet includes an outer surface for printing indicia thereon, an interior surface including a tacky adhesive and a protective cover sheet releasably secured thereto. The closure member includes an upper portion including 25 individual unit labels, each having an interior surface. The 25 unit labels are arranged in a square and are detachably connected along certain perforated lines for separation. The interior surface of each unit label includes the tacky adhesive which contacts the flanges. The lower portion of the closure member includes a plurality of secondary labels. These secondary labels and associated protective cover sheet are perforated along certain lines for removal of each secondary label with its protective cover sheet.

Medi-Dose, Inc. has been selling packages in accordance with those patents. For example, printable cover sheets have been sold under the trademarks Lid-Label® and MediDose®. The cover sheets are configured in different arrays and depend on the type of printer to be used to print the indicia thereon. For example, one cover sheet is sold under the trademark LaserLabel 25 Lid-Label® for applications using a 5×5 package like that disclosed in U.S. Pat. No. 5,603,409. That the cover sheet is arranged to be printed by a laser printer. Other cover sheets have been sold under the trademarks LiquiDose Laser, Mini-LiquiDose Laser and other marks by Medi-Dose, Inc. In addition Medi-Dose, Inc. has provided its customers with software for effecting the printing of the cover sheets with desired indicia, e.g., the name of the pharmaceutical contained in the package, its dosage, instructions for use, warnings, etc.

While that software has proved generally suitable for its intended purposes it leaves something to be desired from the standpoints of ensuring the accuracy of the information that is printed on the cover sheet, visibility of selected information that is printed, ease of use, etc.

Other patents disclosing systems for printing indicia on labels for pharmaceutical carrying packages are U.S. Pat No. 4,818,850 (Gombrich) and U.S. Pat. No. 4,847,764 (Halvorson).

### SUMMARY OF THE INVENTION

In accordance with this invention, there is provided a system and method for printing a label, e.g., a labeled lid, for a package, e.g., a multi-compartment package, containing a prescription or over-the-counter pharmaceutical. The system comprises an input device, e.g., a keyboard or scanner, for providing an input signal representative of the FDA's NDC code for the particular pharmaceutical to be held within the package, a computer, a memory unit, a visual display, a printer, and at least one sheet of printable material capable of having indicia printed thereon. The memory device stores the FDA's NDC codes. The computer and the memory unit are coupled together and to the input device. The computer is arranged for receiving the input signal to compare it to the NDC codes stored in the memory device and for providing an output signal in response thereto. The output signal defines various data associated with the particular pharmaceutical and is coupled to the visual display to produce an image thereon identifying the various data associated with the particular pharmaceutical. The printer is coupled to the computer for receiving a signal therefrom to print indicia on the at least one sheet of printable material. That indicia represents at least some of the data associated with the particular pharmaceutical, e.g., the name of the pharmaceutical, its dosage, etc.

In accordance with one preferred aspect of the invention some of the indicia can be printed in a visually enhanced manner, e.g., in bold, in italics, in color, underscored or combinations thereof.

### DESCRIPTION OF THE DRAWING

FIG. 1 is an illustration of one exemplary embodiment of a system constructed in accordance with this invention for printing out a labeled cover-sheet for a multi-dose prescription drug holding package;

FIG. 2 is a plan view of a labeled cover sheet printed out using the system of the subject invention;

FIG. 3 is a front elevational view of the computer monitor of FIG. 1 shown displaying a “Printer Label” select screen of the software of the system of FIG. 1, which screen is used in the method of the subject invention;

FIG. 4 is a front elevational view of the computer monitor of FIG. 1 shown displaying a “Align Printer” select screen of the software of the system of FIG. 1, which screen is used in the method of the subject invention;

FIG. 5 is a front elevational view of the computer monitor of FIG. 1 shown displaying a “Field Names” select screen of the software of the system of FIG. 1, which screen is used in the method of the subject invention;

FIG. 6 is a front elevational view of the computer monitor of FIG. 1 shown displaying a “Format Fields” select screen of the software of the system of FIG. 1, which screen is used in the method of the subject invention;

FIG. 7 is a front elevational view of the computer monitor of FIG. 1 shown displaying a “Hot Keys” select screen of the software of the system of FIG. 1, which screen is used in the method of the subject invention;

FIG. 8 is a front elevational view of the computer monitor of FIG. 1 shown displaying a “Bar Coding” select screen of the software of the system of FIG. 1, which screen is used in the method of the subject invention;

FIG. 9 is a front elevational view of the computer monitor of FIG. 1 shown displaying a “Print Labels” screen of the software of the system of FIG. 1, which screen is used in the method of the subject invention;

FIG. 10 is a front elevational view of the computer monitor of FIG. 1 shown displaying a “NDC Processing” select screen of the software of the system of FIG. 1, which screen is used in the method of the subject invention; and

FIG. 11 is a front elevational view of the computer monitor of FIG. 1 shown displaying a “Select NDC Information” screen of the software of the system of FIG. 1, which screen is used in the method of the subject invention.

### DETAILED DESCRIPTION OF THE PREFERRED EMBODIMENT

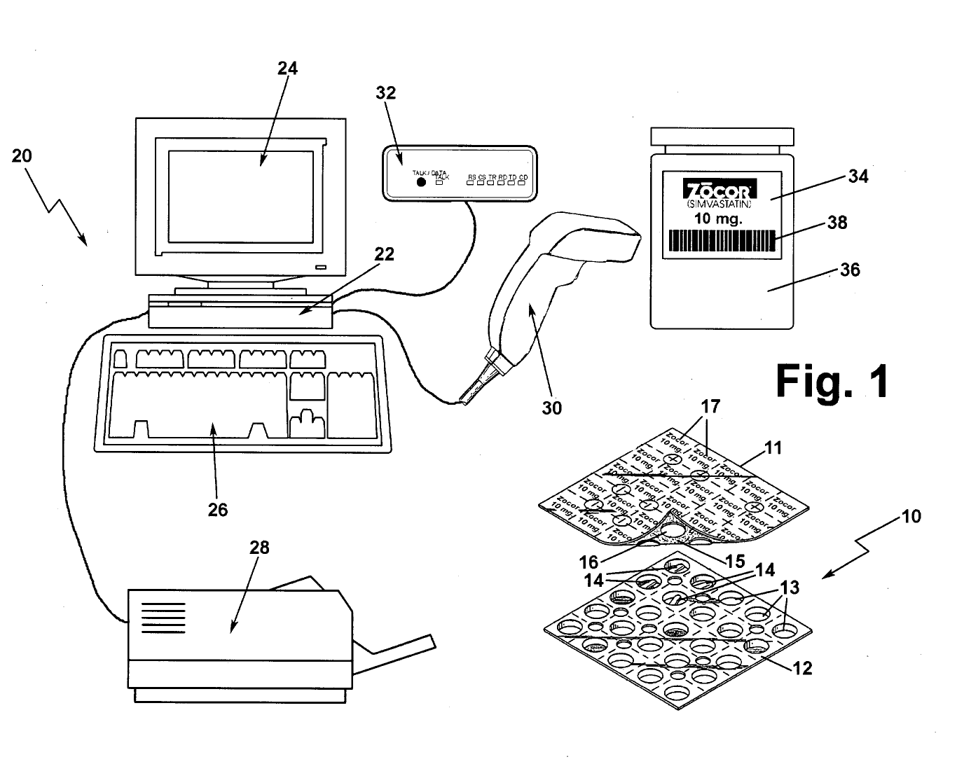

In FIG. 1 there is shown at 20 one exemplary embodiment of a system constructed in accordance with one exemplary embodiment of this invention. The system 20 is arranged to print a label for use on a container holding a dose of a prescription pharmaceutical or a selected over-the-counter drug. In the embodiment of the system 20 shown the label is a Lid-Label® member that forms a portion of a multi-compartment package 10 constructed in accordance with the teachings of the aforementioned U.S. Pat. Nos. 3,780,856 and 5,603,409.

The package 10 basically comprises a cover sheet 11 that is arranged to be adhesively secured to a flanged multi-compartment base 12. The cover sheet forms the lid-label for the package. Each of the compartments 13 of the base 12 is arranged to hold a prescription pharmaceutical or a selected over-the-counter drug 14 therein. The various compartments 13 of the base 12 are interconnected via severable perforated lines in the flanges surrounding the compartments. The cover sheet 11 is correspondingly perforated to define respective unit label covers for the various compartments of the base. The cover sheet 11 includes an adhesive layer 15 on its underside to secure it to the flanges of the multi-compartment base. Protective liner areas 16, each in the forms of a circle, are located on the adhesive over the associated chambers to prevent the pharmaceutical 14 in the chambers from sticking to the adhesive of the cover sheet. The cover sheet is arranged to be printed with various indicia 17 (to be described later) in each of its unit-label areas overlying the package's compartments.

Once the cover sheet is printed and the multi-compartment base is filled, the cover sheet is secured to the base to seal the pharmaceutical doses therein. The package 10 is now ready to be used by either the person to whom the pharmaceuticals are directed or to a caregiver for that person. To that end, the doses of the package can be taken by separating the individual sealed compartments from each other and opening them (e.g., peeling off the cover) to expose the pharmaceutical in the compartment(s).

The system 20 basically comprises a computer 22, a monitor or video display unit 24, a keyboard 26, a printer 28, a bar-code scanner or reader 30 and an optional modem 32 connected to the Internet. The computer includes a memory unit, e.g., a hard drive (not shown) on which the software for effecting the printing of the labels is resident. That software includes a database of the Food and Drug Administration's NDC (National Drug Code) codes for various prescription and over-the-counter drugs. As will be described later, the system 20 of this invention is arranged to have a particular NDC code input therein by the pharmacist or other user of the system to print a cover-sheet bearing selected indicia for the pharmaceutical the specific NDC code represents.

The NDC code can either be input into the system manually, e.g., by the pharmacist typing in the code via the computer keyboard 26 or by automated means, e.g., by scanning a bar code representing the NDC code for the particular pharmaceutical. The NDC code may appear in the manufacturer's or supplier's label 34 and/or on a bulk container 36 holding that pharmaceutical or on some other item, e.g., a list of the NDC codes. In the exemplary embodiment shown, the label 34 includes a bar code 38 representative of the drug in the bulk container 36. In such a case, if the system 20 includes a bar code scanner 30, as does the exemplary system shown in FIG. 1, the user can scan the bar-code 38 to input that NDC code into the software of the system 20, without having to key that code in.

In the exemplary embodiment shown in FIG. 1, the pharmaceutical 14 to be packaged in package 10 is Zocor (simvastatin) whose strength is 10 mg. The NDC code for this drug is contained in the bar-code 38 appearing on the label 36. The NDC code can also appear in human readable form (not shown) on that label.

Once the NDC code is input into the system, the user, e.g., pharmacist, can then decide what information contained in that code, or other information either contained in the software or to be input by the user, is to appear on the cover-sheet 11. Each item of information can be mapped or placed into a desired field for printing on the label or for other use.

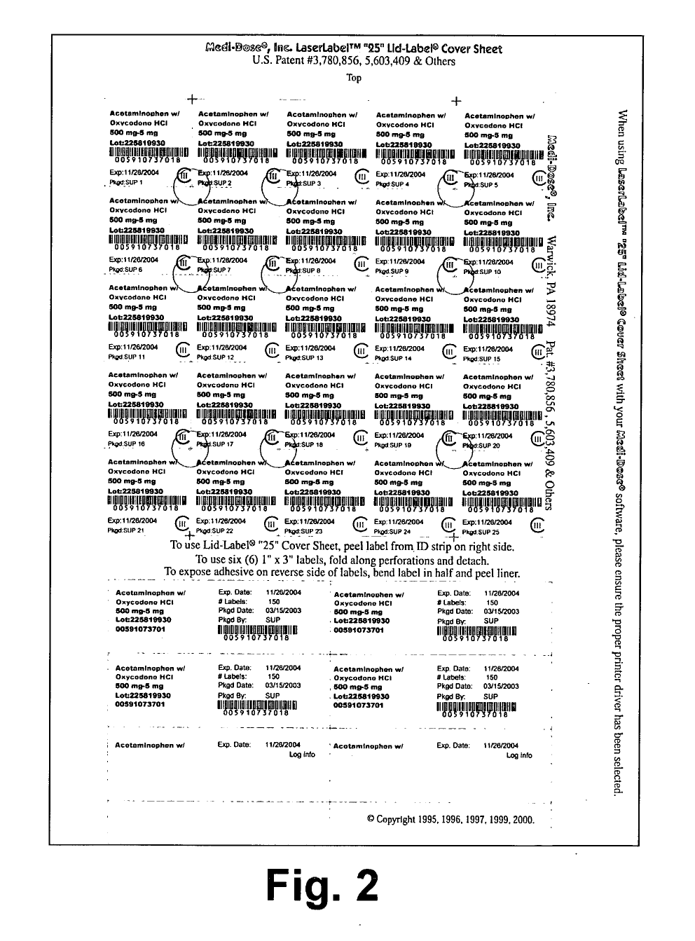

In the exemplary embodiment shown in FIG. 1 only the name of the drug and its strength is shown printed on the cover-sheet. In FIG. 2 there is shown an exemplary cover-sheet printed in accordance with one aspect of this invention and including a 5×5 array of unit lid-labels and six secondary labels, e.g., six one-inch by three inch labels, for a different pharmaceutical, i.e., acetaminophen with oxycodone HCL, with additional indicia printed therein, e.g., expiration date, bar code representing the drug, its strength and lot number.

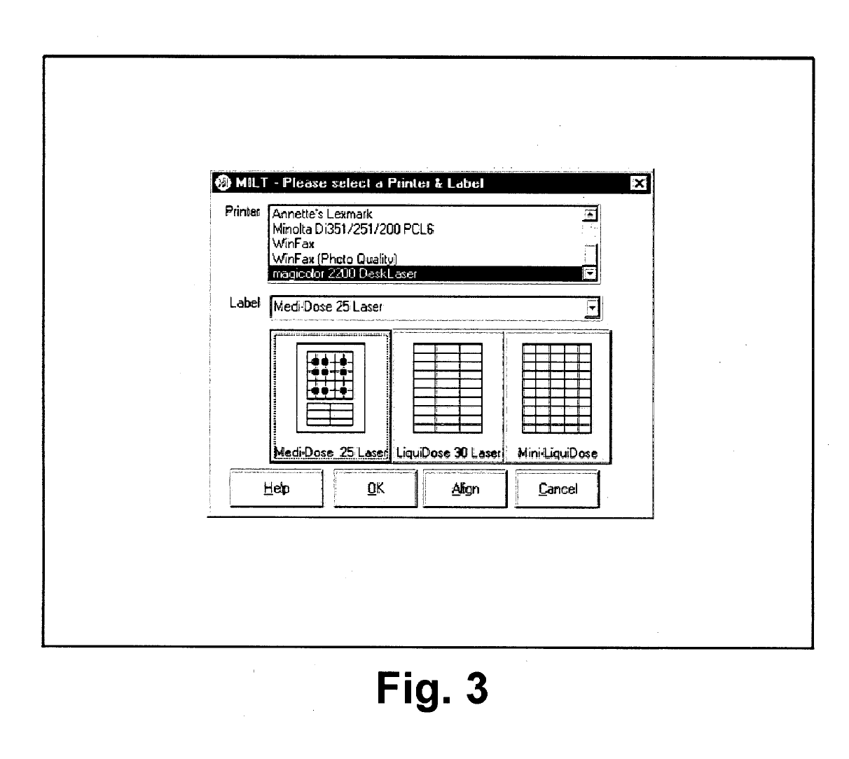

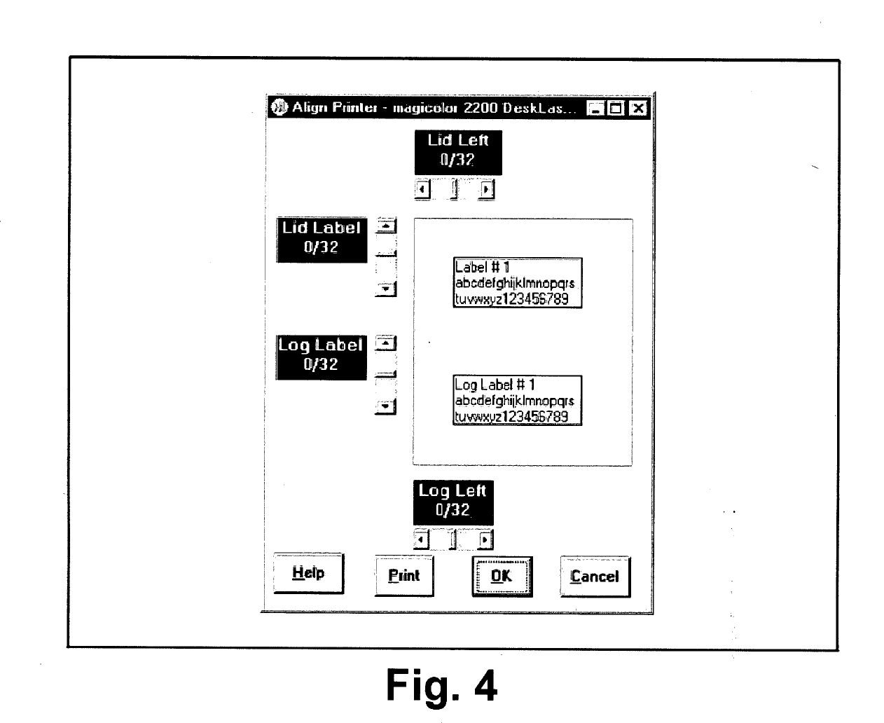

The operation of the system is accomplished by running the software so that various screens appear on the video monitor unit 24 to prompt the user, e.g., pharmacist, to take some action, e.g., provide an appropriate input. In the interest of brevity some of the various screens of the system 20 will not be shown nor described. After the user logs on, the “Printer Setup” screen shown in FIG. 3 will appear. This is where the user selects the particular label and printer being used. To select the label wanted, the user clicks on the appropriate label's graphic on the “Printer Setup” screen. The selected label will be listed under the word “Label.” To select the proper printer, the user highlights the appropriate printer from the printer listings on that screen. The printers listed are those which the user has previously set up for other applications. When first selecting a label and printer, it is desirable to print a test copy of the coversheet lid-label to ensure proper alignment. To that end the user chooses <Align> from the three buttons on the screen to bring up the “Align Printer” screen shown in FIG. 4. The user may then align the label 11 to the chosen printer 28.

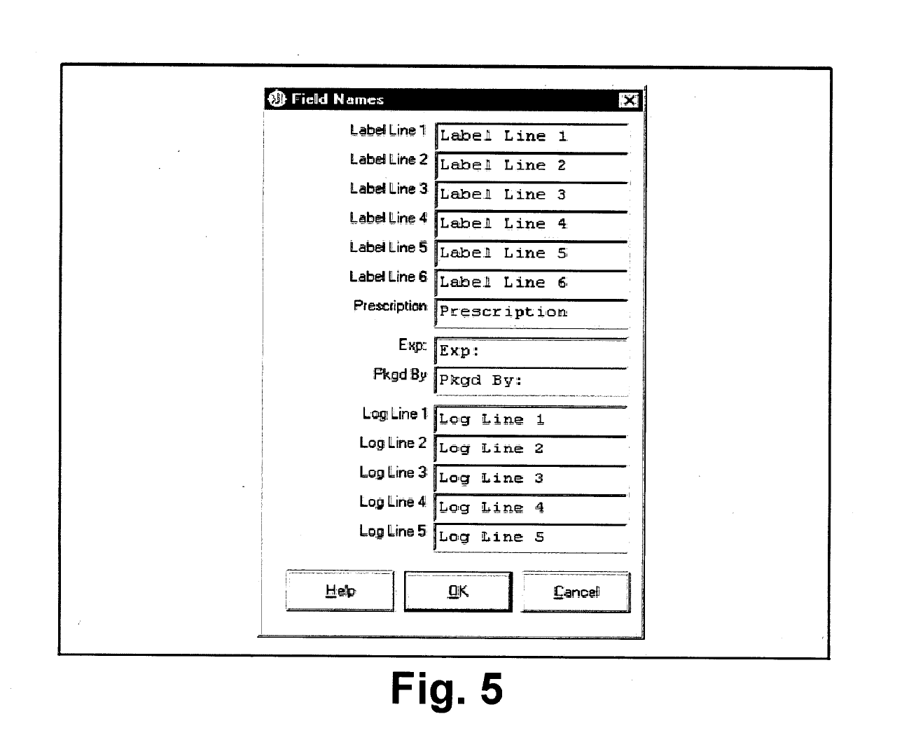

The software of the system 20 enables the user to customize the existing default field names using the screen shown in FIG. 5. This screen should be used as a guide to always put required information in specified, designated fields. The field designations appear at various spots in the program (e.g., Process Using NDC, Label Display) in addition to the data entry fields on the right side of the main work screen. It should be noted that if bar codes are selected through a bar-coding feature of the software (to be described later), the software eliminates Label Line 6 (since this is where the code will print) and instead looks to Label Line 5 for the data to be bar coded.

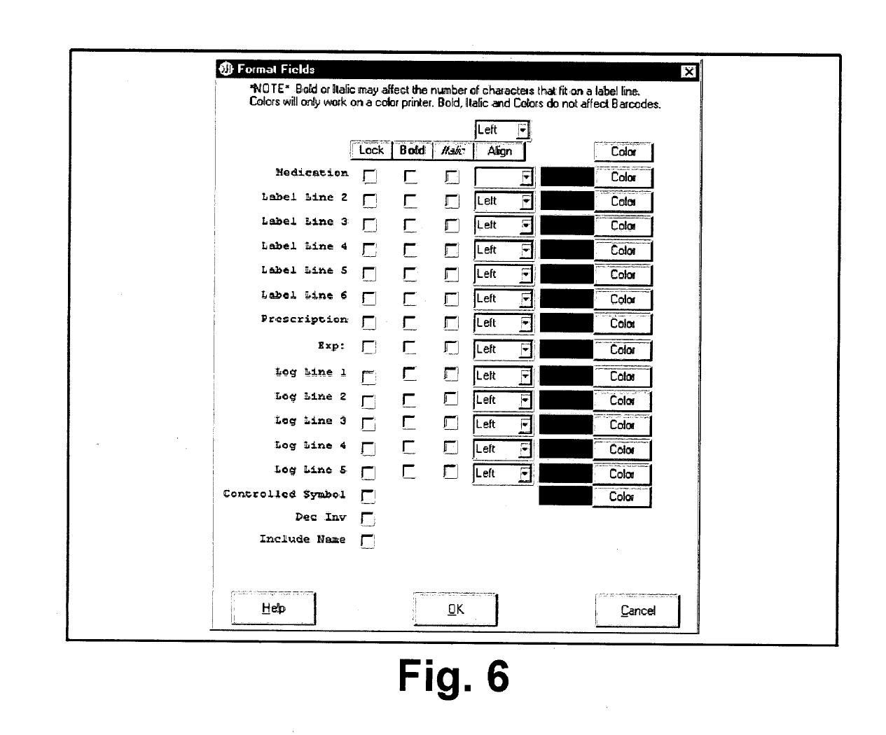

One of the significant features of the system of this invention is the ability of the user to produce a printed label that provides enhanced visibility of any selected field's indicia for increased awareness by the person removing the prescription drug from the package. The mechanism for accomplishing that end is by means of the “Format Field” selection screen shown in FIG. 6. When using that screen the user can globally bold or italicize a specified field or, if desired, every field. To that end the user simply checks the field he/she wishes to place in bold, italics, underscored or in color text and that field will display and print accordingly. In addition, the user can center, left justify or right justify the label's indicia (e.g., text) by pulling the down the drop arrow and selecting the desired choice. By clicking on the Bold or Italic buttons at the top of the grid, the user can globally bold or italicize all data and output from every field. By selecting Left, Center or Right from the drop down menu located above the Align button and then clicking “Align,” every field will be aligned accordingly. In addition, if the printer 28 has color support, the user can print any field in any color. To that end, the user simply clicks on the Color button next to the selected field and selects from the Windows® palette of colors. The field will both display and print in the chosen color. The user can globally select a color by clicking on the Color button at the top of the grid.

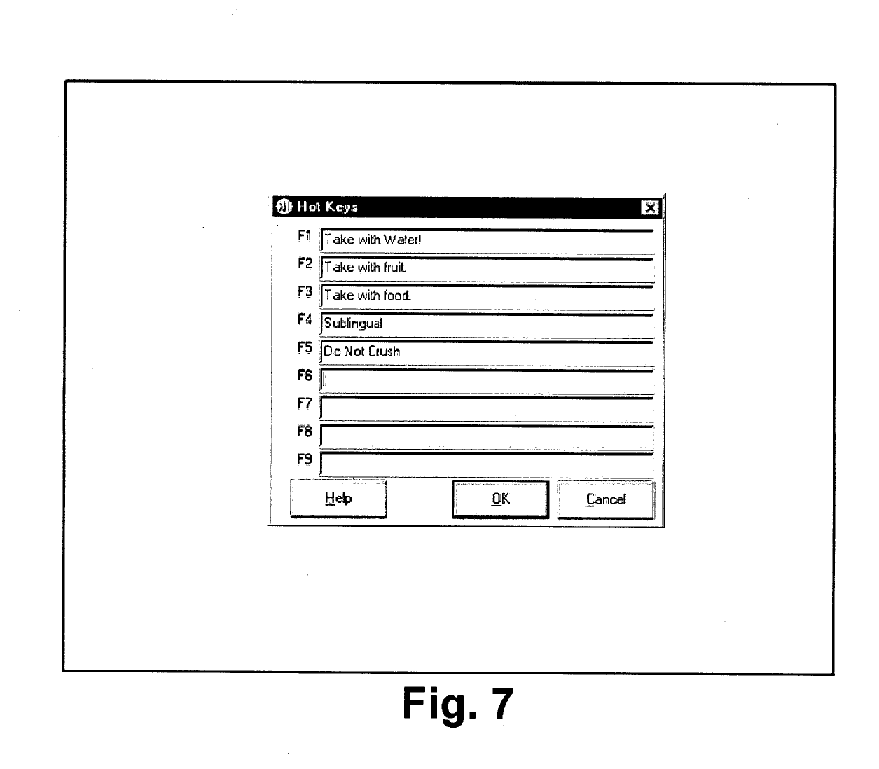

The system of this invention enables the user to program commonly used text to be printed on the labels by accessing the Function keys (F1 through F9). To that end the system provides the user with a “Hot Key” screen. This screen is shown in FIG. 7. All the user has to do is to merely type in the text on the appropriate line when accessing this utility screen. Then, on the label entry screen (to be described later), the user simply hits the appropriate Function Key and the text will appear in that field.

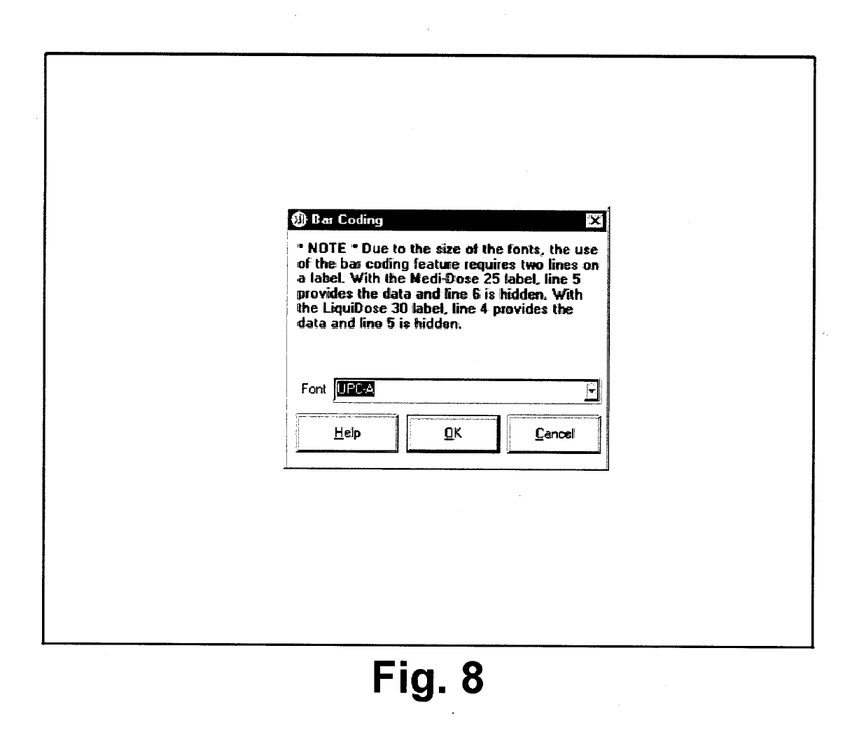

The software of the system 20 enables the user to select a bar code font to print whatever text has been placed in a particular field. This feature is accomplished by means of the screen shown in FIG. 8. To that end, the user types in the name of the particular bar code to be printed, e.g., UPC-A.

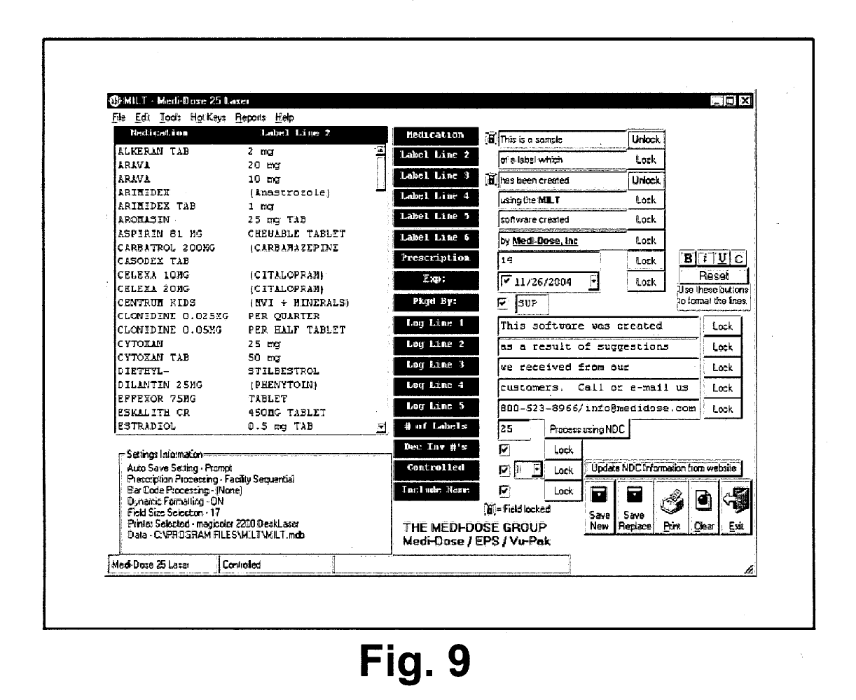

Printing of a lid-label is accomplished by use of the Print Labels screen, shown in FIG. 9. As best seen therein, on the left side of the Print Labels screen is a large blank area. The software enables the user to import data into the system using an import utility. If the user of the system has imported label data using the import utility, the previously entered label formats will appear there. As the user starts entering more label formats, this database area will start to fill up and the Windows® scroll bar will appear. Any format that's listed can be retrieved for editing and printing. The user can either scroll up and down the list to find the particular entry he/she wants or place the mouse cursor in the list and type the first character of the entry he/she is searching for. The first item with that letter will then be highlighted on the left side of the screen.

To enter label formats into the system, all the user has to do is to put the cursor on the first line of the Print Labels Screen and start typing. Since the program alphabetizes the data by what appears on the first line of text, it is suggested that the user put the information that one would most readily recognize on this line. For most applications that would be the name of the medication. (Note: If the user selected different fields to display under the Tools/Change Screen Display utility, then the data will display alphabetically by whatever the user selected as “Screen Display Line 1”).

Inasmuch as the names of pharmaceuticals are often lengthy the system of this invention enables the user to place more text per line. This is accomplished by the software including a field size setting. Thus, the user can choose 17 or 25 characters per line for each of the six text fields which print on one particular lid-label, e.g., LaserLabel Lid-Label Cover.

One of the chief goals of the software of the subject system is to minimize the potential for medication errors during the dispensing and administration process. To that end the software includes a “Dynamic Formatting” feature. When this feature is selected, the user can bold, italicize,underscore or color selected portions of a given field. To that end four buttons appear on the right side of the screen of FIG. 9, one for each function. By using the cursor, the user highlights the selected text desired to be emphasized, and then modifies it accordingly. The data will display in the database and print on the labels as chosen.

The software lets the user enter either 17 or 25 characters per line for Medi-Dose® LaserLabel Lid-Label Covers and 30 characters per line for LiquiDose labels. If the entered text is longer than that, the software truncates it after the 17^{th}/25^{th} and 30^{th} characters respectively.

Separate fields have been established for expiration/beyond use dating and packager. These fields already have data in them whenever a label format has been selected. The expiration/beyond use date always defaults to the date that the user has set through a Date Calculation feature available from a Settings screen (not shown). To change the expiration/beyond use date of the entry, the user either types in the date or click on the down arrow next to the date field. A calendar will pop up. The user can then scroll through the calendar until the expiration/beyond use date desired appears and then the user clicks on it. (Clicking on the year will allow the user to scroll through the calendar year by year). The selected date will then appear in the expiration/beyond use date field. If the user doesn't want an expiration/beyond use date to appear on the package, all that is required is to click the check box next to the date so the check mark disappears. The software will print an expiration/beyond use date, unless otherwise noted.

The initials in the “Packager” field are those of the logged-in user. These initials can appear on both the labels and in the packaging log, identifying who printed the information depending upon the log-in information entered in the initial password screen (not shown) of the software.

Beneath the label text are the fields containing log information. This information will not print on the Lid-Label® sheet, e.g., the LiquiDose® LaserLabel sheet, but it will print at the bottom of the Medi-Dose® LaserLabel Lid-Label® Covers (on the 1″×3″ labels) as well as in both the Medi-Dose® and LiquiDose® packaging logs. These fields provide the user with a text area to include additional information. For example, the user may want to note an expiration/beyond use date on the package and the manufacturer's original expiration date in the log.

In accordance with one preferred aspect of this invention the user is not required to print Lid-Label® covers in multiples of 25. Thus all the user has to do is to simply specify the number of labels (not sheets) he/she wants and the program will print them accordingly. Clicking on the declining inventory number block will print declining numbers in the lower right corner of each individual label.

Clicking on the Controlled box will immediately bring up a drop down screen where the user can select the appropriate type of schedule classification for the medication being prepared. This information will show as such on the Lid-Label® covers and in all reports generated by the system. Moreover, a Controlled “C” designation will print on each label.

At the bottom right of the screen there are five “Action” buttons that enable the user to manipulate his/her way through the data. They are the “Save New” button to be used if the user entered data or has overwritten data on a previously entered format. By clicking this button the user saves the new or revised information as a new format. The “Save Replace” button is to be used if the user has overwritten data of a previously entered format. In such a case he/she can click on this button to save the entry. The “Print” button starts the printing process of the selected label formats. During this process, the user is prompted twice to confirm the number of labels selected. The first confirmation prompt is prior to printing to ensure that the information that the user typed in is, in fact, what is desired. The second confirmation prompt is to ensure that the proper number of labels actually printed (in case there was a printing jam or any problems to the output). Confirmation of this number is noted in a packaging log as having printed that number of labels. The “Clear” button clears any information on the right side of the main label screen and allow the user to “start fresh” on a label format. The “Exit” button enables the user to end the current software usages session.

The software is arranged to be used with a number of conventional bar codes. In particular, one exemplary embodiment of the software includes the ability to be used with the following bar codes: CODABAR, CODE 39, CODE 3 OF 9, USS CODE 39, USD-3, LOGMARS, HIBC, USS CODE 128, UCC-128, ISBT-128, EAN-128, EAN-14, SSCC-18, SSC-14, UPC-A, UPC-E, and EAN-13. These codes are found on Tools/Settings/Bar Code (not shown). The user will need to know which code or codes his/her particular bar code scanning software requires and then select that code from the list in the software of this invention. Regardless of which code is selected, each one has a specific maximum number of characters. The UPC codes have both minimums and maximums. Failure to adhere to the specifications of the selected code may result in the inability or inaccuracy of the user's scanner to correctly read the output. So, it is imperative that the user enter the proper set of characters to be converted into a bar code. For some users, it may be the NDC number of the medication; for others, it may be a particular wholesaler inventory number; for still others, it may be a specific hospital-assigned number. As long as the number meets the parameters of the selected code, the user should receive proper scannable output.

All of the codes available in the software of this invention have been formatted to fit within the 1 3/16″ square Lid-Label® cover or 1″×3″ LiquiDose®) label or the 7/16 inch Mini-LiquiDose cover. Some codes will print only lines. Others will print lines in combination with numbers and/or letters.

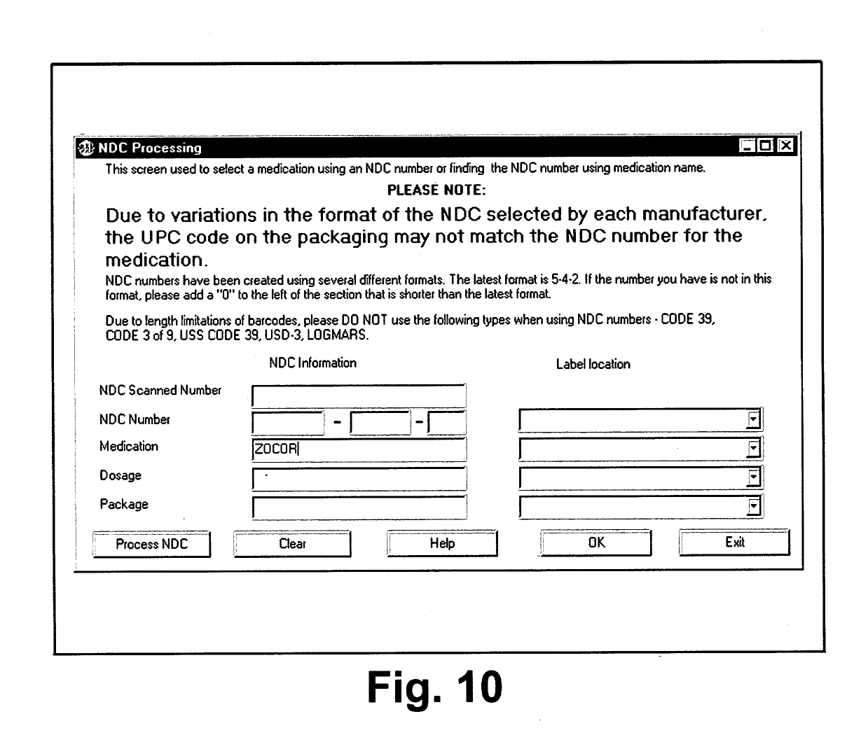

The usage of the bar code feature in the software will now be discussed with reference to the inclusion of the NCD database information. First the user selects the desired bar code font. The user then enters whatever information he/she wishes to bar code simply by typing it in, keeping in mind the parameters of each bar code discussed above. To facilitate the entry of large numbers the software has been designed to interpret input from the scanner. This can be accomplished in a variety of ways. First, if the software has been loaded on the same computer as the bar code scanner, the user can put his/her cursor on the appropriate line of a label entry screen and then scan the code directly from the medication source (e.g., bottle, manufacturer's label, etc.). The actual alpha/numeric code will appear on the screen and will yield the bar code of the chosen font when the label is printed. Alternatively, the user can access an upgradable NDC database. This database contains the updated information on the NDC codes. To utilize this feature the user clicks on the “PROCESS USING NDC” button that appears on the main label printing screen (FIG. 9). When this is done, the screen shown in FIG. 10 will appear for usage.

The software contains an extensive database of NDC numbers for virtually all prescription drugs and certain selected over-the-counter (OTC) medications. This information is taken directly from the FDA and is the most comprehensive database that the FDA maintains.

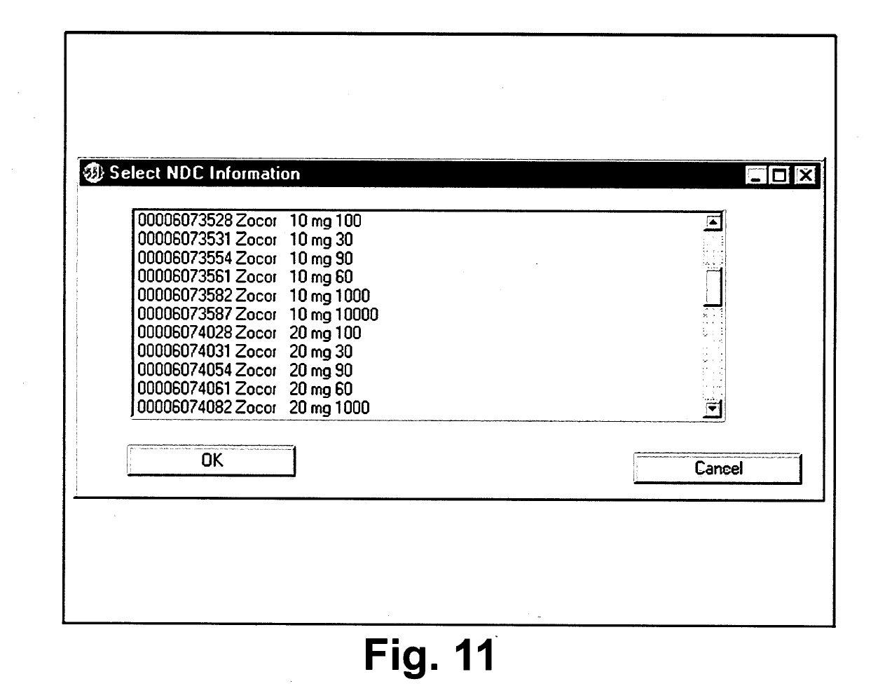

There are two ways the user can access this data and have it print on the labels. One way is to place the cursor on the NDC Scanned Number line of the screen of FIG. 10 and scan in the NDC number or type in the NDC number on the NDC Number line from the medication source. When the scanned number appears in the field, the user can then click on the Process NDC button so that the medication, dosage and original packaging information will appear on the screen. When the data appears, the user can then map that information to the designated field(s) based on what he/she had entered under Tools/Settings/Field Names just by clicking on the pull down arrows at the right of the Label Location fields. In FIG. 11 there is shown the NDC Processing screen, which enables the user to look up the NDC code for any particular drug, e.g., Zocor in various dosages and quantities.

The database of NDC information of the system 20 is arranged to be updated from time to time by the system of this invention. If the software of this invention has been loaded on a computer with an Internet connection, e.g., via modem 32, the user can download updates to the NDC database. To that end, if the user wants to upgrade, all he/she has to do is to click on the “Update NDC Information from Website” button of the screen of FIG. 9. The software then takes the user to an update screen, so that the updated NDC information can be downloaded to the system. If the user doesn't have an Internet connection, but still wants to use the NDC database and keep current with the updates, this can be accomplished by downloading the updated database from some other computer having an Internet connection and saving the updated database on some medium, e.g., a CD-ROM. Once the database has been downloaded (either to a file on a computer within the user's network or to a CD-ROM), the user then can go to Tools/Settings/Import NDC Data screen (not shown) and while using the browse command, find the database file and update the file.

It should be pointed out at this juncture that while the system and method as disclosed heretofore has focused on unit dose packaging, it should be appreciated that this invention can be used to print any kind of labels for any type of drug container or package.

The use of the NDC database to match scanned or typed-in NDC codes minimizes the potential for error in the medication being packaged. In particular, now the user, be it a pharmacist or other person dispensing the drug, can either type in the NDC number for the drug (taking that information off of the label on the bulk container holding the drug or off of some other item bearing the NDC code for that drug) or can scan the NDC code off of the label of the bulk container (assuming that the bulk container's label bears a scannable code) or any other item bearing the NDC code in scannable form. Once the NDC code is input, either by keyboard or scanning, the software of this invention displays the drug's name, its strength and packaging and other relevant information. This information can then be mapped to designated fields on the label, so that the user never has to type any drug name information. Moreover, since the software of this invention enables the NDC information to be mapped to designated fields the system provides for uniformity of data and reduces the potential for medication dispensing and identification errors.

The dynamic formatting aspect of this invention allows the user to combine bold, italicized, underscoring and color to any portion of the label fields for increased visibility and awareness of the ultimate user and for the person printing the labels. To that end the fields desired to exhibit the enhanced visibility indicia are provided in that format on the computer monitor or screen to facilitate the printing of that indicia by the user of the system. Thus, not only does the person who will be using the printed pharmaceutical-containing package gain the benefits of having selected indicia rendered in an enhanced-visibility manner, but also the person printing the cover sheet can see that the desired indicia has been appropriately enhanced before the cover sheet is printed. The enhanced visibility indicia serves to reduce the possibility of error in dispensing and/or taking. For example, by utilizing different fonts and colors for different drugs that may be spelled similarly, the chances of a person taking the wrong medication is reduced.

The labels 11 that have been printed can, if desired, have a bar-code identifying the specific individual dose. The bar-code can then be read by virtually any commercially available scanning equipment. Moreover, the labels can be printed to include the capability to work with CPOE (Computerized Physician Order Entry) and BPOC (Bar-Code Point of Care system) applications that are prevalent in the health care industry today.

While not described above, the software of one commercial embodiment of this invention enables an entry to be made on a packaging log (which can be printed), an entry to be made to an expiration report (which also can be printed), as well as entries made to a template report and an audit trail when the labels are printed. The audit trail allows the pharmacist or other user of the system to track the history of a particular label format to ensure the integrity of the data and the performance of personnel using the system. In addition the software of that commercial embodiment enables selected fields to be locked by supervisory personnel to maintain integrity of the data. Further still that software is designed to be readily exported to other programs. Further yet, the software enables the maintenance of detailed packaging logs of both label and ancillary information.

As should be appreciated from the foregoing the subject invention provides a dynamic new manner of effecting unit dose labeling for various types of packaging systems that is accurate, secure and easy to use.

Without further elaboration the foregoing will so fully illustrate my invention that others may, by applying current or future knowledge, adopt the same for use under various conditions of service.

I claim:

1. A system for printing a label for a package containing a pharmaceutical, comprising an input device for providing an input signal representative of the FDA's NDC code for the particular pharmaceutical to be held within the package, a computer, a memory unit, a visual display, a printer, and at least one sheet of printable material capable of having indicia printed thereon, said memory device storing the FDA's NDC codes, said computer and said memory unit being coupled together and to said input device, said computer being arranged for receiving said input signal and comparing said input signal with the NDC codes stored in said memory device for providing an output signal, said output signal defining various data associated with said particular pharmaceutical, said output signal being coupled to said visual display, whereupon said visual display produces an image identifying various data associated with said particular pharmaceutical, said printer being coupled to said computer for receiving a signal therefrom to print indicia on said at least one sheet of printable material, said indicia representing at least some of the data associated with said particular pharmaceutical.

2. The system of claim 1 wherein said indicia comprises at least the name of said pharmaceutical and the dosage thereof.

3. The system of claim 1 wherein said system is configured to enable some of the indicia to be printed in a visually enhanced manner.

4. The system of claim 1 wherein said input device comprises a keyboard.

5. The system of claim 1 wherein said input device comprises a bar code scanner.

6. The system of claim 1 additionally comprising means for importing the NDC code into said system.

7. The system of claim 6 wherein said means for importing the NDC code into the system comprises a connection to the Internet.

8. The system of claim 1 wherein said at least one sheet of printable material constitutes a lid for a multi-compartment package, with said lid being divided into a plurality of sections, each of said sections arranged to close off an associated compartment in said multi-compartment package, and wherein said system is arranged to print said indicia on at least selected ones of said plurality of sections.

9. The system of claim 8 wherein said input device comprises a keyboard.

10. The system of claim 8 wherein said input device comprises a bar code scanner.

11. A method for printing a label for a package containing a pharmaceutical, comprising:
(A) providing a computer, a memory unit, a visual display, a printer, and at least one sheet of printable material capable of having indicia printed thereon, said memory device storing said FDA NDC code, said computer and said memory unit being coupled together and to said input device,
(B) providing an input signal representative of the FDA's NDC code for the particular pharmaceutical to be held within the package to said computer, whereupon said computer compares said input signal with the NDC code stored in said memory device for providing an output signal, said output signal defining various data associated with said particular pharmaceutical,
(C) providing said output signal to said visual display, whereupon said visual display produces an image identifying various data associated with said particular pharmaceutical, and
(D) selecting at least some of the data displayed on said screen to provide a signal to said printer to print indicia on said at least one sheet of printable material, said indicia representing at least some of the data associated with said particular pharmaceutical.

12. The method of claim 11 wherein said indicia comprises at least the name of said pharmaceutical and the dosage thereof.

13. The method of claim 11 additionally comprising printing selected ones of said indicia in a visually enhanced manner.

14. The method of claim 13 wherein said visually enhanced manner comprises bold indicia, italicized indicia, underscored indicia, or colored indicia and/or combinations thereof.

15. The method of claim 11 wherein said input signal is provided via a keyboard.

16. The method of claim 11 wherein said input signal is provided by reading a bar code.

17. The method of claim 11 wherein said NDC code is updated by importation from the Internet.

18. The method of claim 11 wherein said at least one sheet of printable material constitutes a lid for a multi-compartment package, with said lid being divided into a plurality of sections, each of said sections being arranged to close off an associated compartment in said multi-compartment package, and wherein said method additionally comprises printing said indicia on at least selected ones of said plurality of sections.
